(19) United States
(12) Patent Application Publication
(10) Pub. No.: US 2014/0360933 A1
(43) Pub. Date: Dec. 11, 2014

(54) METHODS AND APPARATUS FOR NITROGEN REMOVAL FROM WASTEWATER

(71) Applicants: Babak Rezania, Vancouver (CA); Tina Shoa, Vancouver (CA)

(72) Inventors: Babak Rezania, Vancouver (CA); Tina Shoa, Vancouver (CA)

(21) Appl. No.: 14/345,330

(22) PCT Filed: Jun. 15, 2012
(86) PCT No.: PCT/US12/42655

§ 371 Date: Mar. 17, 2014

Related U.S. Application Data
(60) Provisional application No. 61/535,863, filed on Sep. 16, 2011.

(51) Int. Cl. C02F 3/30

(52) U.S. Cl. CPC C02F 3/307; C02F 2101/16
USPC 210/605

(57) ABSTRACT

The present invention is directed to equipment, systems and methods for the biological removal of nitrogen from wastewater. The ammonium removal processes disclosed herein can be used in both batch and continuous flow biological reactors with real time control of nitrogen loading to effectively cultivate ammonium oxidizing bacteria alone, as well as in a mixture of ammonium oxidizing bacteria with anaerobic ammonium oxidizing bacteria in a single bioreactor. Both batch and continuous flow biological reactors have a mean of separating solids retention time (SRT) of suspended nitrifying biomass from suspended anammox biomass.

### CROSS-REFERENCE TO RELATED APPLICATIONS

The present PCT patent application claims priority benefit of the U.S. provisional application for patent Ser. No. 61/535,863 and entitled “METHODS AND APPARATUS FOR NITROGEN REMOVAL FROM WASTEWATER” filed on Sep. 16, 2011 under 35 U.S.C. 119(e). The contents of these related provisional and patent applications are incorporated herein by reference for all purposes.

### TECHNICAL FIELD OF THE INVENTION

The present invention relates generally to the field of wastewater treatment, and more particularly, to processes and equipment for biological nitrogen removal from wastewater.

### BACKGROUND OF THE INVENTION

While the invention is useful for many applications, it is directed in particular to the biological removal of nitrogen from wastewater streams.

Nitrogen is mainly found in wastewater in the form of ammonium nitrogen (NH₄—N). The most common approach for removing ammonium from water is biological, based on the use of microorganisms to convert ammonium to nitrogen gas through a series of steps referred collectively as nitrification and denitrification. The conventional biological nitrification-denitrification of wastewater is typically conducted and managed within contained systems commonly referred to as bioreactors. Suitable bioreactors for nitrification and denitrification of wastewater encompass in situ open-systems such as lagoons, ponds, basins and open-top tanks; and ex situ closed-systems such as tanks and other enclosed vessels. In both types of bioreactor systems, microorganisms may be grown in suspension in the liquid or alternatively, may be attached to solid growth support media thereby forming biofilms.

The performance of conventional nitrification-denitrification is limited to the availability of organic carbon, thereby necessitating the addition of external organic carbon to drive denitrification in many wastewaters. This imposes the disadvantages of high operating costs, treatment costs associated with the added organic carbon donor substrates for denitrification, elevated sludge production and associated removal costs.

An alternative approach for the biological removal of ammonium from wastewater is through the combined partial nitrification followed by anaerobic ammonium oxidation, referred to as anammox. Combined partial nitrification-anammox is a shortcut to conventional nitrification-denitrification and relies on different microorganisms to drive the process. It's advantages over conventional nitrification-denitrification are: (a) the cost of aeration will be much lower and less sludge will be produced; (b) the denitrification using anammox is carried out by autotrophic bacteria and does not require organic carbon for denitrification; and (c) the anammox microorganisms are more environmentally friendly since the bacteria consume carbon dioxide as the carbon source as opposed to conventional denitrification which releases carbon dioxide (a greenhouse gas) to the atmosphere.

The combined partial nitrification and anammox process is a two stage biological reaction, where ammonium ion (NH₄⁺) is partially oxidized to nitrite (NO₂⁻) by ammonium oxidizing bacteria:

4NH₄⁺3O₂→2NH₄⁺+2NO₂⁻+4H⁺+2H₂O

Partial nitrification produces a mixture of ammonium and nitrite (NO₂⁻) which serves as the feed for anammox bacteria. The resulting ammonium (NH₄⁺) and nitrite (NO₂⁻) are converted in the anammox process to dinitrogen (N₂) gas and approximately 15% nitrate (not shown) by the anammox bacteria:

NH₄⁺+NO₂⁻→N₂+2H₂O

The partial nitrification-anammox process can take place in one reactor systems or two reactor systems. In one reactor systems, both partial nitrification and anammox take place in a single reactor whereas in two reactor systems anammox follows partial nitrification in a separate reactor. Kuai and Verstraete (1998) published a paper in the Journal of Applied and Environmental Microbiology (Volume 64, No. 11, Page 4500-4506) where a sequential batch reactor (SBR) operating under low dissolved oxygen was used to cultivate a mixture of anammox and ammonium oxidizing bacteria. Using a constant cycle length, intermittent aeration was provided by a pH controlled mechanical mixer that was turned on and off by pH readings in the bioreactor. Only 40% total nitrogen was achieved in the bioreactor.

There are numerous challenges associated with the successful operation of anammox based nitrogen removal systems operated in batch and continuous flow regimes. One of these challenges is free ammonia toxicity whereby high elevations of ammonia (NH₃) in the reactor leads to a decrease in the rate of anammox activity and to nitrite accumulation which leads to toxicity. Another challenge is in the start-up phase, where sufficient quantities of anammox biomass in the reactor are required. Low concentrations will cause nitrite (NO₂⁻) accumulation leading to irreversible toxicity of the anammox bacteria. The performance of a system is also affected by the carbon to nitrogen ratio levels. Furthermore, previously disclosed methods are prone to failure of the control systems due to operational problems such as ammonium oxidizing bacteria being inhibited by a verity of chemicals (Martin, 2008, PhD. thesis Deammonification Process Kinetics and Inhibition Evaluation, Department Civil Engineering, VirginiaTech University) and false pH increase readings from carbon dioxide stripping. Lastly, the level of flexibility in the control mechanisms of previously disclosed systems is limited and provisions for various applications such as nitrification. Bio-augmentation while being capable of improving nitrogen removal and dealing with influent nitrogen and temperate fluctuations has not been incorporated into their design.

Therefore, it is an object of the present invention to provide equipment, systems and methods for the treatment of nitrogen containing wastewaters by a multifunctional process which will result in a fast start up anammox system which also addresses the limitations described above; including, a system which is not affected by the change in the concentrations of various nitrogen species in the wastewater to be treated.

It is further an object of the present invention to provide equipment, systems and methods for the treatment of nitrogen containing wastewater which will maintain a high degree of stability, resulting in a high quality treated liquid even if the ammonium concentration or temperature in the wastewater increases or decreases by automatically adjusting the reaction length.

It is still further an object of the present invention to provide equipment and systems that are robust and highly versatile in the treatment of a variety of wastewaters, particularly high ammonium and phosphorus wastewaters, such as dewatered sludge liquors produced at sewage treatment plants, and animal wastewaters. The system disclosed herein can readily function in various modes of operation based on the type of wastewater to be treated, it's applications, and the end user's requirements.

A practical example of the flexibility of the disclosed invention is its ability to function in various modes of operation to satisfy the end user's specifications. For instance, if the system is to be utilized for the treatment of dewatered sludge liquors at wastewater treatment plants, the choice of treatment processes can be varied based on the local treatment plant discharge regulations.

Furthermore, the processes disclosed in the present invention can work in a nitrifying mode; a nitrifying mode for bio-augmentation applications; and an anaerobic ammonium oxidation mode while serving as a pre-treatment for phosphorus recovery when a combined nitrogen removal and phosphorus recovery application is desired.

It will thus be seen that the present invention provides equipment, systems and methods which allow for versatile processes to be used in the cost effective removal of ammonium nitrogen from various wastewaters such as rejected water from sludge digesters , landfill leachate, liquid manure and any other high ammonium wastewater as well as other applications such as pre-treatment or post treatment for phosphorus recovery and generating nitrifying seed for bio-augmentation applications.

Reference herein included by reference in their entirety are:

1—Type of Document Dissertation Author Musabyimana, Martin, 2008. PhD. thesis Deammonification Process Kinetics and Inhibition Evaluation, Department Civil Engineering, VirginiaTech University

2—Wett, B./Rostek, R./Rauch, W./Ingerle, K., pH-controlled reject-water-treatment Water Science and Technology, 37 (12), p.165, January 1998

3—LINPING KUAI AND WILLY VERSTRAETE, Ammonium Removal by the Oxygen-Limited Autotrophic Nitrification-Denitrification System, ENVIRONMENTAL MICROBIOLOGY, November 1998, p. 4500-4506

### SUMMARY OF INVENTION

The present invention is directed to equipment, systems and methods for the biological removal of nitrogen from wastewater. The ammonium removal processes disclosed herein can be used in both batch and continuous flow biological reactors with realtime control of nitrogen loading to effectively cultivate ammonium oxidizing bacteria alone, as well as a mixture of ammonium oxidizing bacteria with anaerobic ammonium oxidizing bacteria in a single bioreactor. The disclosed invention uses pH as a control mechanism to control the nitrogen loading to a bioreactor. The length of reaction in the bioreactor is automatically adjusted to produce a quality effluent regardless of the ammonium concentration in the wastewater or the change in temperature. The systems described work in various modes of operation by increasing the air flow without needing to change the design.

### BRIEF DESCRIPTION OF DRAWINGS

The present invention is described in conjunction with reference to the following drawings which illustrate embodiments of the invention, but which should not be construed as restricting the spirit or scope of the invention in any way.

FIG. 1 is a schematic of a batch flow apparatus for ammonium oxidation and removal from wastewater.

FIG. 2 is a schematic of a continuous flow apparatus for ammonium oxidation and removal from wastewater.

FIG. 3 is a flow chart describing a method for ammonium oxidation and removal from wastewater.

### DETAILED DESCRIPTION OF EMBODIMENTS

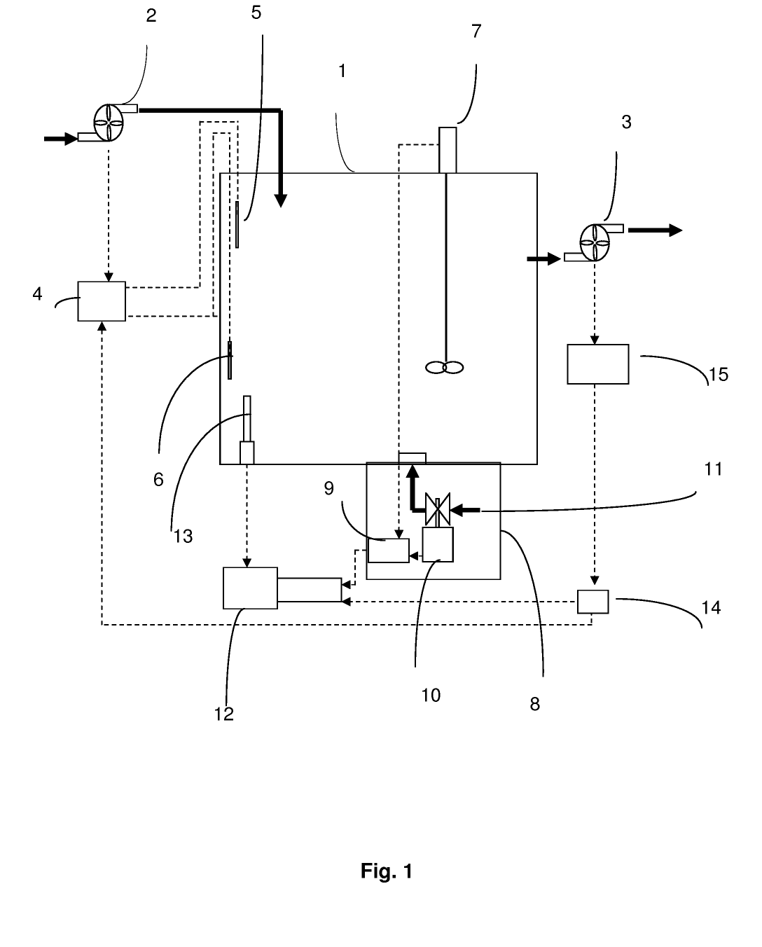

According to a first preferred aspect of the present invention, there is provided a multifunctional batch wastewater treatment process for biological ammonium oxidation and removal from wastewater. In reference to FIG. 1, a schematic of a batch flow reactor system is shown having a bioreactor vessel (1) for the holding and treating of wastewater. The bioreactor vessel (1) is equipped with an inflow pumping device (2) for transferring the wastewater into the bioreactor vessel, and an outflow pumping device (3) for decanting the treated wastewater from the bioreactor vessel. A level control device (4) controls the level of wastewater in the bioreactor vessel (1) and the volume of the liquid pumped into the bioreactor vessel (1). The level control device (4) is connected to a first level switch (5), and a second level switch (6). The level control device (4) controls the power to the inflow pumping device (2) and outflow pumping device (3). A mixing device (7) and an aeration device (8) provide mixing and aeration which trigger biological activity in the bioreactor vessel (1). The aeration device (8) includes a timer (9) and solenoid valve (10) which is connected to a compressed air source (11). An input/output programmable logic controller (PLC) device (12) receives signals from a pH sensor (13) that is in contact with wastewater in the bioreactor vessel (1). The PLC device (12) simultaneously controls the length of an aeration cycle, the degree of mixing, and the power to the outflow pumping device depending on the signal from the pH sensor (13). The outflow pumping device (3) is connected to a switch (14) and timer (15) which controls the power to the outflow pumping device (3).

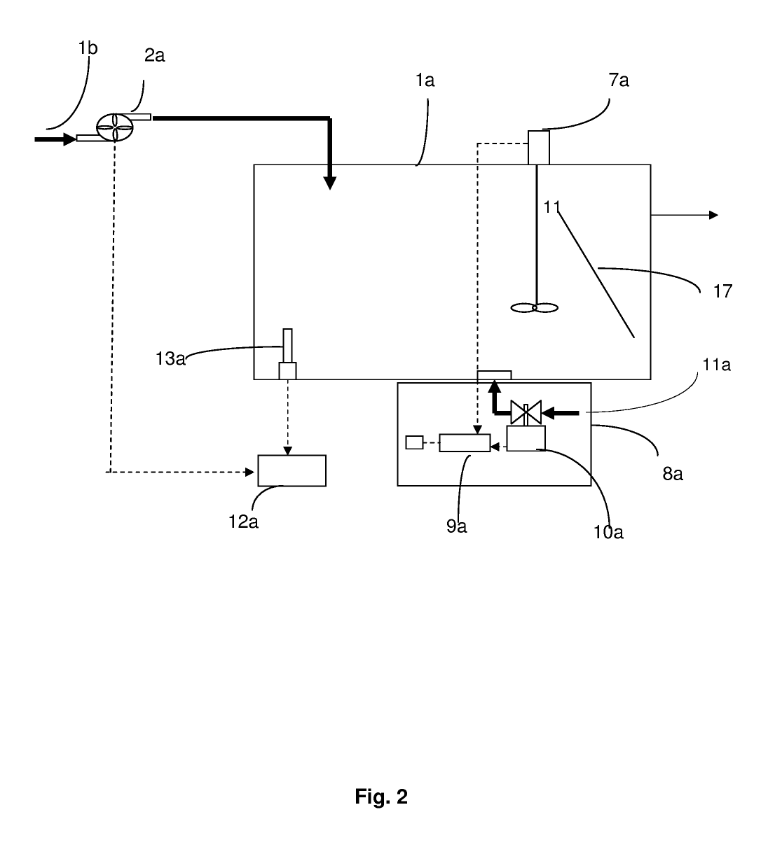

According to a second preferred aspect of the present invention, a continuous flow wastewater treatment process for biological ammonium oxidation and removal from wastewater is disclosed. A schematic of a continuous flow system used for this process is shown in FIG. 2. The process provides a system to control the nitrogen loading of the bioreactor vessel (1a) and can trigger the growth of ammonium oxidizing bacteria alone as well as the growth of a mixture of ammonium oxidizing bacteria and anaerobic ammonium oxidizing bacteria. The apparatus shown in FIG. 2 is composed of a bioreactor vessel (1a) for holding and treating wastewater. The bioreactor vessel (1a) has a liquid inflow line (1b), and an inflow pumping device (2a) for pumping the wastewater into the bioreactor vessel (1a). The bioreactor vessel (1a) is equipped with a mixing device (7a) and an aeration device (8a) that provide mixing and aeration which trigger biological activity in the bioreactor vessel (1a). The aeration device (8a) includes a timer (9a) and solenoid valve (10a) that is connected to a compressed air source (11a). An input/output PLC device (12a) receives a signal from a pH sensor (13a) that is in contact with wastewater in the bioreactor vessel (1a). The PLC device (12a) is in communication with inflow pumping device (2a) turning the pumping device on and off based on the pH set point in the bioreactor vessel (1a). The treated wastewater is then separated from biomass in the bioreactor vessel (1a) via a solid separation device (17). The solid separation device can be a clarifier or membrane filter or any device capable of separating liquid from solid.

The two systems described above allow for multifunctional processes with the systems operating under a nitrifying mode or an anammox mode in order to satisfy the requirements of various applications. Unlike prior biological systems, the performance of the disclosed systems are not affected by temperature. Although the rate of the reaction in the bioreactor vessel(s) can be affected by temperature, the liquid produced in the system will still be of high quality since the length of the reaction is adjusted automatically to compensate for the change in temperature.

1. A third aspect of the invention is a method for biological ammonium removal which incorporates a mixture of ammonium oxidizing bacteria and anammox bacteria into the process described in the first aspect of the invention. The method comprises introducing the wastewater into a batch reactor such as the one disclosed in FIG. 1 and subjecting the wastewater to air in a controlled manner. The wastewater may be pre-treated anaerobically to convert the organics in the wastewater to biogas prior to subjecting the wastewater to controlled aeration. During start up, the aeration timer provides intermittent aerations and nitrite levels are measured. The aeration device (8) is adjusted so that the level of nitrite nitrogen (NO₂—N) in the tank does not exceed the level toxic to anammox bacteria. The aeration continues until the pH of the wastewater declines to a lower value, in the range of 5.8 to 6.5 (gas liquid equilibrium pH with atmosphere). Once the set point pH value is reached the aeration system is turned off and the treated wastewater is separated from the biomass in the reactor through settling means or by a solid separation device. The settling time is an important step in the process and is adjusted to separate the solids retention time (SRT) of suspended nitrifying biomass (i.e. nitrite oxidizing bacteria and ammonium oxidizing bacteria) from anammox granular biomass. The nitrifying biomass will have lower solids retention time than anammox biomass by adjusting the settling time and decant volume to generate conditions for the nitrifying biomass to be wasted to the effluent.

This method allows for the cultivation of both ammonium oxidizing bacteria and anaerobic ammonium oxidizing bacteria to work simultaneously to convert ammonium nitrogen (NH₄—N) to nitrogen gas (N₂), while nitrite oxidizing bacteria will wash out of the bioreactor vessel. During the treatment process carbonate alkalinity is consumed causing a decline in the pH of the wastewater.

A preferred method for biological ammonium removal from wastewater containing ammonium includes the steps of a) introducing a volume of wastewater into a bioreactor vessel seeded with sludge containing ammonium oxidizing bacteria and anaerobic ammonium oxidizing bacteria (anammox bacteria); b) subjecting the wastewater to a controlled aeration to the extent that carbonate alkalinity is consumed by ammonium oxidizing bacteria resulting in a decrease in pH while the nitrite nitrogen concentration is kept below the toxic level to anammox bacteria; and c) stopping the aeration and separating the biomass in the bioreactor vessel from treated wastewater when the pH of the wastewater declines and reaches a set point value in the range of 5.8-6.5 (gas liquid equilibrium pH with atmosphere).

According to a fourth preferred aspect of the present invention, a method for biological ammonium oxidation in wastewater is disclosed. The method comprises introducing the wastewater into a batch bioreactor (FIG. 1) and subjecting the wastewater to aeration so that the nitrite (NO₂⁻) concentration is higher than the concentration to tolerable by anammox bacteria. This method allows for the cultivation of ammonium oxidizing bacteria which converts ammonium nitrogen (NH₄—N) to nitrite (NO₂⁻) and or mixture of nitrite (NO₂⁻) and nitrate (NO₃⁻). During the treatment process carbonate alkalinity is consumed by bacteria causing a decline in the pH of wastewater.

According to a fifth preferred aspect of the present invention, a method is described for biological ammonium removal from wastewater. The method comprises continuously or semi continuously (see FIG. 2) introducing the wastewater into a bioreactor and then subjecting the wastewater to aeration to an extent that it does not inhibit the growth of anaerobic ammonium oxidizing bacteria in order to cultivate a mixture of ammonium oxidizing bacteria and anaerobic ammonium oxidizing bacteria. The inflow and outflow wastewater into the bioreactor is controlled by the pH of the liquid in the bioreactor. The wastewater is continuously flowing into the bioreactor unless the pH of the liquid in the bioreactor exceeds the set point pH.

A preferred method for continuous or semi-continuous biological ammonium removal from wastewater containing organics and ammonium include the steps of: a) introducing the wastewater into a bioreactor vessel seeded with sludge containing ammonium oxidizing bacteria and anaerobic ammonium oxidizing bacteria (anammox bacteria); b) subjecting the wastewater to a controlled aeration to the extent that carbonate alkalinity is consumed by ammonium oxidizing bacteria resulting in a decrease in pH while the nitrite nitrogen concentration is kept below the level toxic to anammox bacteria; and c) controlling the flow of the wastewater into the bioreactor vessel by stopping the flow if the pH of the wastewater in the bioreactor vessel rises above the pH set point value which is set between 5.8-6.5 (gas liquid equilibrium pH with atmosphere). D) Separating the treated wastewater from biomass in the bioreactor vessel using a baffle or a clarifier where the SRT of suspended nitrifying biomass (i.e. nitrite oxidizing bacteria and ammonium oxidizing bacteria) are reduced during clarification using up flow velocity higher that settling velocity of nitrifying biomass. During clarification by increasing the up flow velocity, the nitrifying biomass are transfered to the effluent while the anammox bacteria are retained in the bioreactor

In both batch and continuous flow wastewater treatment processes the bioreactor vessel may be equipped with a biomass retention device such as a external clarifier, membrane or media for increasing biomass retention in the bioreactor vessel. In case a clarifier is used for solid separation

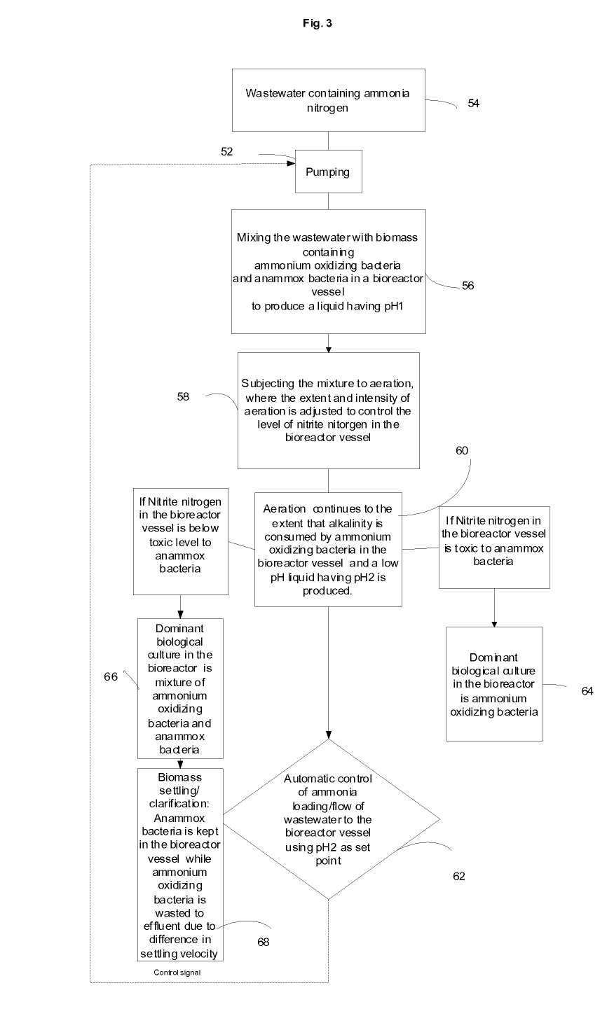

FIG. 3 shows a flow chart describing a method for treating wastewater containing ammonium. The method comprises the steps of 1: using a wastewater transfer method such as a pumping device or gravity (52) to transfer wastewater containing ammonium (54) into a bioreactor vessel; 2: mixing the wastewater with a biomass containing a mixture of ammonium oxidizing bacteria and anammox bacteria to produce a liquid having pH1 (56); 3: subjecting the mixture in the bioreactor vessel to aeration where aeration can be provided continuously or intermittently in a controlled manner to control the nitrite nitrogen concentration in the bioreactor (58); 4: continuing the aeration to the extent that alkalinity in the bioreactor vessel is consumed and pH of the mixture is reduced to pH2 (60); and finally step 5: using pH2 as a set point to control the extent of the reaction and ammonium loading into the bioreactor vessel (62). This method can be used in bioreactor vessels operated in either batch or continuous flow systems depending on aeration rate, the dominant microbial culture in the bioreactor vessel are ammonium oxidizing bacteria (64) or a mixture of ammonium oxidizing bacteria and anammox bacteria (66); the method is also allows for separation of solid retention time of nitrifying bacteria from anammox bacteria in the bioreactor vessel. (68).

1-18. (canceled)

19. A method for biological ammonium oxidation and removal from wastewater comprising the steps of:
transferring wastewater containing ammonium to a bioreactor;
forming a mixture by mixing the wastewater with a suspended biomass comprising an ammonium oxidizing biomass having ammonium oxidizing bacteria and an anammox biomass having anammox bacteria to produce a liquid having a first pH;
subjecting said mixture in said bioreactor to aeration;
continuing said aeration until a reaction occurs to an extent that alkalinity in said bioreactor is consumed and pH of said liquid is reduced to a second pH;
separating anammox biomass from the wastewater; and
wasting the ammonium oxidizing bacteria through effluent while retaining said anammox bacteria in said bioreactor using settling velocity differences between said anammox biomass and said ammonium oxidizing biomass.

20. The method of claim 19 wherein:
said separating is done using a timer to allow for settling of said anammox biomass within the bioreactor; and
decanting said wastewater after said separating.

21. The method of claim 19 wherein said second pH is used as a set point for real time control of ammonia loading to said bioreactor.

22. The method of claim 19 wherein said second pH is used as a set point between 5.8 and 6.5.

23. The method of claim 19 wherein said aeration is provided in a controlled manner to control nitrite to nitrogen concentration in said bioreactor.

24. The method of claim 19 wherein a mixture of ammonium oxidizing bacteria and anammox bacteria is grown in said bioreactor by adjusting the aeration to keep nitrite to nitrogen concentration below a level toxic to anammox bacteria.

25. The method of claim 19 wherein said bioreactor is a batch bioreactor and a settling time is used to control a solids retention time (SRT) of suspended anammox biomass to be higher than that of suspended nitrifying biomass using a settling velocity difference between said anammox biomass and said suspended nitrifying biomass.

26. The method of claim 24 wherein said suspended nitrifying biomass comprises nitrite oxidizing bacteria and ammonium oxidizing bacteria.

27. The method of claim 24 wherein the SRT of said suspended nitrifying biomass is less than said anammox biomass.

28. The method of claim 24 wherein media is added to said bioreactor to increase retention of said anammox biomass in said bioreactor.

29. The method of claim 19 wherein said bioreactor is a continuous flow bioreactor having a clarifier wherein an upflow velocity of liquid in the clarifier is used to control a solids retention time (SRT) of suspended anammox biomass to be higher than suspended nitrifying biomass using a settling velocity difference between anammox biomass and suspended nitrifying biomass.

30. The method of claim 29 wherein said suspended nitrifying biomass comprises nitrite oxidizing bacteria and ammonium oxidizing bacteria.

31. The method of claim 29 wherein the SRT of suspended nitrifying biomass is less than anammox biomass.

32. The method of claim 29 wherein media is added to said bioreactor to increase retention of said anammox biomass in said bioreactor.

33. The method of claim 19 wherein said effluent containing said ammonium oxidizing bacteria is added to a non nitrifying biological reactor to trigger nitrification in said non nitrifying reactor.

34. The method of claim 19 wherein a concentration of nitrifying biomass in said effluent of the bioreactor is increased by increasing said aeration to produce a nitrite to nitrogen concentration toxic to anammox bacteria.

35. The method of claim 19 wherein said second pH is used as a set point in said bioreactor and correlates to ammonium nitrogen concentration in the effluent; the set point being used to control effluent nitrogen to phosphorus molar ratio optimum for struvite recovery.

36. A method for biological ammonium oxidation and removal from wastewater containing ammonium comprising the steps of:
introducing a volume of wastewater into a bioreactor seeded with sludge containing ammonium oxidizing bacteria and anammox bacteria;
subjecting the wastewater to a controlled aeration to an extent that carbonate alkalinity is consumed by said ammonium oxidizing bacteria resulting in a decrease in pH while nitrite to nitrogen concentration is kept below a level toxic to anammox bacteria;
stopping the aeration; and
separating biomass in the bioreactor from treated wastewater when pH of the wastewater declines and reaches a set point between 5.8 and 6.5.

37. The method of claim 36 wherein the wastewater is separated from the biomass in the reactor through settling means or by a solid separation device.

38. A method for biological ammonium oxidation and removal from wastewater comprising the steps of:
transferring wastewater containing ammonium to a bioreactor;
forming a mixture by mixing the wastewater with a suspended comprising an ammonium oxidizing biomass having ammonium oxidizing bacteria and an anammox biomass having anammox bacteria to produce a liquid having a first pH;
subjecting said mixture in said bioreactor to aeration;
continuing said aeration until a reaction occurs to an extent that alkalinity in said bioreactor is consumed and pH of said liquid is reduced to a second pH;
separating anammox biomass from wastewater by using settling time of said anammox biomass within the bioreactor, wherein the settling time is used to control a solids retention time (SRT) of suspended anammox bacteria to be higher than that of a suspended nitrifying biomass using settling velocity differences between said anammox biomass from said suspended nitrifying biomass;
decanting said wastewater after said separating; and
wasting said suspended nitrifying biomass through effluent while retaining said anammox biomass in said bioreactor.

39. The method of claim 38 wherein said second pH is a set point between 5.8 and 6.5.
